(19) United States
(12) Patent Application Publication
(10) Pub. No.: US 2009/0039811 A1
(43) Pub. Date: Feb. 12, 2009

(54) Inhibitors of HSP90

(76) Inventors: Patrick Chene, Mulhouse (FR); Andreas Floersheimer, Dornach (CH); Pascal Furet, Thann (FR); Joseph Schoepfer, Riehen (CH)

Correspondence Address: NOVARTIS INSTITUTES FOR BIOMEDICAL RESEARCH, INC., 400 TECHNOLOGY SQUARE, CAMBRIDGE, MA, 02139, US

(21) Appl. No.: 11/658,234

(22) PCT Filed: Jul. 26, 2005
(86) PCT No.: PCT/EP2005/008119

§ 371 Date: Oct. 14, 2008

Related U.S. Application Data
(60) Provisional application No. 60/591,329, filed on Jul. 27, 2004.

(51) Int. Cl. H02P 7/29; H02K 7/14

(52) U.S. Cl. 318/434; 310/50

(57) ABSTRACT

The invention relates to the use of 1H-indazol-6-ol compounds and salts thereof in the treatment of proliferative diseases and for the manufacture of pharmaceutical preparations for the treatment of said diseases, pharmaceutical preparations comprising 1H-indazol-6-ol compounds, novel 1H-indazol-6-ol compounds, and a process for the preparation of the novel 1H-indazol-6-ol compounds.

### SUMMARY OF THE INVENTION

The invention relates to methods of use of 1H-indazol-6-ol derivatives in the treatment of proliferative diseases, pharmaceutical preparations comprising 1H-indazol-6-ol derivatives for the treatment of said diseases, or for the manufacture of pharmaceutical compositions for use in the treatment of said diseases. The present invention also relates to novel 1H-indazol-6-ol derivatives, pharmaceutical preparations comprising these 1H-indazol-6-ol derivatives, processes for the manufacture of the novel 1H-indazol-6-ol derivatives and pharmaceutical preparations, and novel intermediate compound used in the manufacture of 1H-indazol-6-ol derivatives.

### BACKGROUND OF THE INVENTION

The Hsp90 family of chaperones is comprised of four known members: Hsp90α and Hsp90β both in the cytosol, grp94 in the endoplasmic reticulum and trap-1 in the mitochondria. Hsp90 is an abundant cellular chaperone required for the ATP-dependent refolding of denatured or “unfolded” proteins and for the conformational maturation of a variety of key proteins involved in the growth response of the cell to extracellular factors. These proteins, which are called client proteins, include the steroid receptors as well as various protein kinases. Hsp90 is essential for eukaryotic cell survival and is overexpressed in many tumors. Cancer cells seem to be sensitive to transient Inhibition of Hsp90 ATPase activity suggesting that Hsp90 Inhibitors could have a potential as new anticancer drugs. Each Hsp90 family member possesses a conserved ATP-binding site at its N-terminal domain, which is found in few other ATP-binding proteins. The weak ATPase activity of Hsp90 is stimulated upon its interaction with various co-chaperone proteins. Several natural compounds such as geldanamycin or radicicol bind at the ATP-binding site of Hsp90 inhibiting its ATPase activity. In cellular systems and In vivo, these drugs upon binding to Hsp90 prevent the folding of the client proteins, which are then degraded in the proteasome. 17-allylamino-17-demethoxygeldanamycin (17-AAG), a geldanamycin derivative, is currently in Phase I clinical trial at several institutions. Initial clinical experiences with 17-MG have offered preliminary evidence that concentrations of the drug associated with activity in pre-clinical systems can be achieved in humans with tolerable toxicity, and provided early evidence of target modulation in at least certain surrogate and tumor compartments. The dose limiting toxicity of 17-AAG is hepatic. 17-MG poor solubility makes it difficult to formulate/administer and its synthesis is difficult (it is generally obtained by fermentation). Therefore synthetic compounds with better physicochemical properties and may be of higher specificity (17-AAG inhibits all these the four Hsp90 paralogs) are needed in clinic.

There is an ever-existing need to provide novel classes of compounds that can inhibit Hsp90 and therefore trigger apoptosis of proliferating cells.

We have now found that the 1H-indazol-6-ol residue can be also be used as template for the design of compounds which act as Hsp90 inhibitors.

### GENERAL DESCRIPTION OF THE INVENTION

The class of 1H-indazol-6-ol compounds described herein, especially novel compounds falling under this class, has surprisingly been found to have pharmaceutically advantageous properties, inter alia, as Hsp90 inhibitors.

### DETAILED DESCRIPTION OF THE INVENTION

The invention in particular relates to 1H-indazol-6-ol compounds of the formula (I):

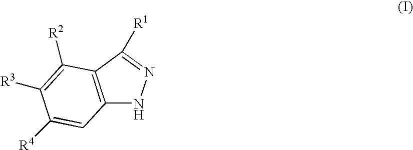

wherein:
R¹ is substituted or unsubstituted lower alkyl, substituted or unsubstituted aryl, or substituted or unsubstituted aryl lower alky;
R² is H, halo, hydroxy, lower alkyl or a group of the formula:

—Y—R⁵

where Y is O, N, S or lower alkyl and R⁵ is substituted or unsubstituted lower alkyl, or substituted or unsubstituted aryl;
R³ is H, halo, or substituted or unsubstituted lower alkyl, substituted or unsubstituted aryl, substituted or unsubstituted cycloalkyl, substituted or unsubstituted cycloalkyl-alkyl or substituted or unsubstituted arylalkyl;

### R⁴ is H or OH;

or pharmaceutically acceptable salts thereof,
in the treatment of proliferative diseases, especially those dependent on Hsp90 activity, or for the manufacture of pharmaceutical compositions for use in the treatment of said diseases, methods of use of compounds of formula (I) In the treatment of said diseases, pharmaceutical preparations comprising compounds of formula (I) for the treatment of said diseases, compounds of formula (I) for use in the treatment of said diseases.

The general terms used hereinbefore and hereinafter preferably have within the context of this disclosure the following meanings, unless otherwise indicated:

“Alkyl” includes lower alkyl preferably alkyl with up to 10 carbon atoms, preferably from 1 to and including 5, and is linear or branched; preferably, lower alkyl is methyl, ethyl, propyl, such as n-propyl or isopropyl, n-butyl, isobutyl, sec-butyl, tert-butyl, straight or branched pentyl, straight or branched hexyl, straight or branched heptyl, straight or branched nonyl or straight or branched decyl. Preferably alkyl is C₁ to C₄-alkyl especially methyl, ethyl, propyl, 2-methyl propyl and t-butyl. The alkyl group may be unsubstituted or substituted with any of the substituents defined below, preferably halo, hydroxy, lower alkoxy (such as methoxy), phenyl, cycloalkyl, lower alkyl or substituted lower alkyl (such as diphenyl methyl).

Most preferably the alkyl group is a lower alkyl of 1-4 carbon atoms, preferably methyl, ethyl, propyl, butyl, isobutyl, tertbutyl, and isopropyl.

Most preferably the alkyl group is substituted with halo, amino, cyclopropyl or substituted or unsubstituted phenyl.

“Aryl” is an aromatic radical having 6 to 14 carbon atoms, which is unsubstituted or substituted by one or more, preferably one or two substituents, wherein the substituents are as described below. Preferred “aryl” is phenyl or naphthyl which may be substituted with any of the substituents defined below, preferably lower alkyl (such as methyl or trifluoromethyl); lower alkoxy (such as methoxy); hydroxy; amine lower alkoxy; alkyl amino alkoxy (such —O—(CH₂)₂NR′R″ where R′ and R″ can be H or lower alkyl); halo (such as chloro or fluoro); or n-phenylacetamide where the phenyl is substituted with H, methyl, ethyl, lower alkyl, trifluoromethyl, lower alkoxy, F or Cl.

A “cycloalkyl” group means C₃ to C₁₀-cycloalkyl having 3 to 8 ring carbon atoms and may be, for example, cyclopropyl, cyclobutyl, cyclopentyl, cyclohexyl, cycloheptyl or cyclooctyl. Preferably, cycloalkyl is cyclopropyl. The cycloalkyl group may be unsubstituted or substituted with any of the substituents defined below.

Any of the above defined aryl, alkyl, cycloalkyl, may be unsubstituted or independently substituted by up to four, preferably one, two or three substituents, selected from the group consisting of: halo (such as F, Cl or Br); hydroxy; lower alkyl (such as C₁-C₃ lower alkyl); lower alkyl which may be substituted with any of the substituents defined herein; lower alkenyl; lower alkynyl; lower alkanoyl; alkoxy (such as methoxy); aryl (such as phenyl or benzyl); substituted aryl (such as alkyl phenyl, alkoxy phenyl, amino alkoxy phenyl, alkyl amino alkoxy phenyl or dialkyl amino alkoxy phenyl); amino; mono- or disubstituted amino; amino alkyl (such as dimethylamino); acetyl amino; amino alkoxy (such as amino ethoxy); alkyl amino alkoxy; dialkyl amino alkoxy; alkoxy amino (such as ethoxyamine); N-phenylacetamide; nitro; cyano; cyano lower alkyl; carboxy; esterified carboxy (such as lower alkoxy carbonyl e.g. methoxy carbonyl); n-propoxy carbonyl or iso-propoxy carbonyl; alkanoyl; benzoyl; carbamoyl; N-mono- or N,N-disubstituted carbamoyl; carbamates; alkyl carbamic acid esters; amidino; guanidine; urea; ureido; mercapto; sulfo; lower alkylthio; sulfoamino; sulfonamide; benzosulfonamide; sulfonate; sulfanyl lower alkyl (such as methyl sulfanyl); sulfoamino; substituted or unsubstituted sulfonamide (such as benzo sulfonamide); substituted or unsubstituted sulfonate (such as chloro-phenyl sulfonate); lower alkylsulfinyl; phenylsulfinyl; phenyl-lower alkylsulfinyl; alkylphenylsulfinyl; lower alkanesulfonyl; phenylsulfonyl; phenyl-lower alkylsulfonyl; alkylphenylsulfonyl; halogen-lower alkylmercapto; halogen-lower alkylsulfonyl; such as especially trifluoromethane sulfonyl; phosphono (—P(═O)(OH)₂); hydroxy-lower alkoxy phosphoryl or di-lower alkoxyphosphoryl; substituted urea (such as 3-trifluoro-methyl-phenyl urea); alkyl carbamic acid ester or carbamates (such as ethyl-N-phenyl-carbamate) or —NR′R″, wherein R′ and R″ can be the same or different and are independently H; lower alkyl (e.g. methyl, ethyl or propyl); or R′ and R″ together with the N atom form a 3- to 8-membered heterocyclic ring containing 1-4 nitrogen, oxygen or sulfur atoms (e.g. piperazinyl, pyrazinyl, lower alkyl-piperazinyl, pyridyl, indolyl, thiophenyl, thiazolyl, n-methyl piperazinyl, benzothiophenyl, pyrrolidinyl, piperidino or imidazolinyl) where the heterocyclic ring may be substituted with any of the substituents defined herein.

Preferred substituents for the above groups include alkyl (such as methyl or trifluoromethyl), phenyl, alkoxy, (such as methoxy), amino alkoxy, aminoethoxy, alkyl amino alkoxy, halo (such as F or Cl), or n-phenylacetamide.

Where the plural form is used for compounds, salts, pharmaceutical preparations, diseases and the like, this is intended to mean also a single compound, salt, or the like.

Salts are especially the pharmaceutically acceptable salts of compounds of formula (I).

Such salts are formed, for example, as acid addition salts, preferably with organic or inorganic acids, from compounds of formula (I) with a basic nitrogen atom, especially the pharmaceutically acceptable salts. Suitable Inorganic acids are, for example, halogen acids, such as hydrochloric acid, sulfuric acid, or phosphoric acid. Suitable organic acids are, for example, carboxylic, phosphonic, sulfonic or sulfamic acids, for example acetic acid, trifluoroacetic acid, propionic acid, octanoic acid, decanoic acid, dodecanoic acid, glycolic acid, lactic acid, fumaric acid, succinic acid, adipic acid, pimelic acid, suberic acid, azelaic acid, malic acid, tartaric acid, citric acid, amino acids, such as glutamic add or aspartic acid, maleic acid, hydroxymaleic acid, methylmaleic acid, cyclohexanecarboxylic acid, adamantanecarboxylic acid, benzoic acid, salicylic acid, 4-aminosalicylic acid, phthalic acid, phenylacetic acid, mandelic acid, cinnamic acid, methane- or ethane-sulfonic acid, 2-hydroxyethanesulfonic acid, ethane-1,2-disulfonic acid, benzenesulfonic acid, 2-naphthalenesulfonic acid, 1,5-naphthalene-disulfonic acid, 2-, 3- or 4-methylbenzenesulfonic acid, methylsulfuric acid, ethylsulfuric acid, dodecylsulfuric acid, N-cyclohexylsulfamic acid, N-methyl-, N-ethyl- or N-propyl-sulfamic acid, or other organic protonic acids, such as ascorbic acid.

In the presence of negatively charged radicals, such as carboxy or sulfo, salts may also be formed with bases, e.g. metal or ammonium salts, such as alkali metal or alkaline earth metal salts, for example sodium, potassium, magnesium or calcium salts, or ammonium salts with ammonia or suitable organic amines, such as tertiary monoamines, for example triethyl-amine or tri(2-hydroxyethyl)amine, or heterocyclic bases, for example N-ethyl-piperidine or N,N′-dimethylpiperazine.

When a basic group and an acid group are present in the same molecule, a compound of formula (I) may also form internal salts.

For isolation or purification purposes it is also possible to use pharmaceutically unacceptable salts, for example picrates or perchlorates. For therapeutic use, only pharmaceutically acceptable salts or free compounds are employed (where applicable in the form of pharmaceutical preparations), and these are therefore preferred.

In view of the close relationship between the compounds in free form and those in the form of their salts, including those salts that can be used as intermediates, for example in the purification or Identification of the compounds, tautomers or tautomeric mixtures and their salts, any reference to the compounds hereinbefore and hereinafter especially the compounds of the formula (I), is to be understood as referring also to the corresponding tautomers of these compounds, especially of compounds of the formula (I), tautomeric mixtures of these compounds, especially of compounds of the formula (I), or salts of any of these, as appropriate and expedient and if not mentioned otherwise.

Where “a compound . . . , a tautomer thereof; or a salt thereof” or the like is mentioned, this means “a compound . . . , a tautomer thereof, or a salt of the compound or the tautomer”.

Any asymmetric carbon atom may be present in the (R)-, (S)- or (R,S)-configuration, preferably in the (R)- or (S)-configuration. Substituents at a ring at atoms with saturated bonds may, if possible, be present in cis-(=Z-) or trans (=E-) form. The compounds may thus be present as mixtures of isomers or preferably as pure isomers, preferably as enantiomer-pure diastereomers or pure enantiomers.

### PREFERRED EMBODIMENTS ACCORDING TO THE INVENTION

In the following preferred embodiments, general expression can be replaced by the corresponding more specific definitions provided above and below, thus yielding stronger preferred embodiments of the Invention.

Preferred is the USE of compounds of the formula (I) or pharmaceutically acceptable salts thereof, where the disease to be treated is a proliferative disease depending on Hsp90 and/or a hsp90 client protein or a tumor which overexpresses Hsp90.

The invention relates especially to a compound of the formula (I),

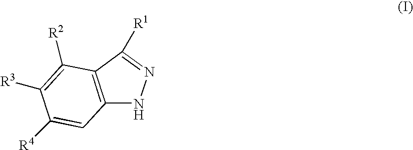

wherein:
R¹ is substituted or unsubstituted lower alkyl, substituted or unsubstituted aryl, or substituted or unsubstituted aryl lower alky;
R² is H, halo, hydroxy, lower alkyl or a group of the formula:

—Y—R⁵

where Y is O, N, S or lower alkyl and R⁶ is substituted or unsubstituted lower alkyl, or substituted or unsubstituted aryl;
R³ is H, halo, or substituted or unsubstituted lower alkyl, substituted or unsubstituted aryl, substituted or unsubstituted cycloalkyl, substituted or unsubstituted cycloalkyl-alkyl or substituted or unsubstituted arylalkyl;

### R⁴ is H or OH;

or pharmaceutically acceptable salts thereof,
in the treatment of proliferative diseases, especially those dependent on Hsp90 activity, or for the manufacture of pharmaceutical compositions for use in the treatment of said diseases, methods of use of compounds of formula (I) in the treatment of said diseases, pharmaceutical preparations comprising compounds of formula (I) for the treatment of said diseases, compounds of formula (I) for use in the treatment of said diseases.

In another embodiment, the Invention further relates to a compound of formula (I) and its use in the treatment of proliferative diseases or for the manufacture of pharmaceutical preparations, wherein:

R¹ is lower alkyl (such as methyl or ethyl); substituted lower alkyl (such as benzyl or phenyl ethyl) or phenyl which is unsubstituted or substituted with H, lower alkyl, lower alkoxy (such as methoxy), amine lower alkoxy (such as amino ethoxy), lower alkyl amino alkoxy or dialkylamino alkoxy (such as methyl amino ethoxy or dimethyl amino ethoxy);
R² is H, halo (such as F), hydroxy, lower alkyl or a group of the formula:

—Y—R⁵

where Y is O, N, S or lower alkyl and R⁵ is lower alkyl or aryl; examples of R⁵ include phenyl, naphthyl, phenoxy, phenyl amino, phenyl thio, phenyl ethyl, benzyl, wherein the phenyl or naphthyl group of R⁵ is preferably substituted with H, lower alkyl, lower alkoxy (such as methoxy), halo, trifluoromethyl, N-phenylacetamide, amine lower alkoxy (such as amino ethoxy), lower alkyl amino alkoxy or dialkylamino alkoxy (such as methyl amino ethoxy or dimethyl amino ethoxy);
R³ is H, Cl, methyl, trifluoromethyl, ethyl, propyl, isopropyl, butyl, tert-butyl or iso-butyl or pharmaceutically acceptable salts thereof.

In a preferred embodiment, R² is H, F, OH, or a group selected from

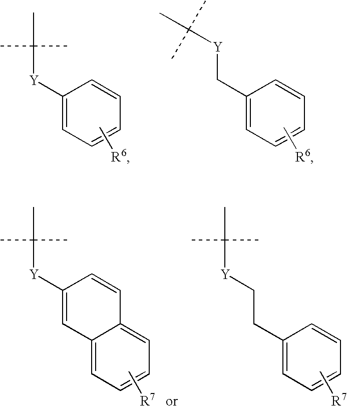

where R⁶ is H, lower alkyl (such as methyl or ethyl), CF₃, lower alkoxy, halo (such as F or Cl) and R⁷ is R⁶ or

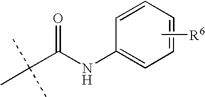

which is preferably in the para position for phenyl and position 6 for naphthyl.

Where subsequently the term “USE” is mentioned, this includes any one or more of the following embodiments of the invention, respectively: the use in the treatment of proliferative diseases, especially those dependant on Hsp90 activity, the use for the manufacture of pharmaceutical compositions for use in the treatment of said diseases, pharmaceutical preparations comprising 1H-indazol-6-ol derivatives for the treatment of said diseases, and 1H-indazol-6-ol derivatives for use in the treatment of said diseases, as appropriate and expedient, if not stated otherwise. In particular, diseases to be treated and are thus preferred for USE of a compound of formula (I) are selected from proliferative diseases, more especially diseases that depend on Hsp90 activity.

In a broader sense of the invention, a proliferative disease includes hyperproliferative conditions, such as leukemias, hyperplasias, fibrosis (especially pulmonary, but also other types of fibrosis, such as renal fibrosis), angiogenesis, psoriasis, atherosclerosis and smooth muscle proliferation in the blood vessels, such as stenosis or restenosis following angioplasty. In another aspect the compounds of the present invention could be used to treat arthritis.

Very preferred is a method of treating a proliferative disease, preferably a benign or especially malignant tumor, more preferably carcinoma of the brain, kidney, liver, adrenal gland, bladder, breast, stomach (especially gastric tumors), ovaries, colon, rectum, prostate, pancreas, lung (especially SCLC), vagina, thyroid, sarcoma, glioblastomas, multiple myeloma or gastrointestinal cancer, especially colon carcinoma or colorectal adenoma, or a tumor of the neck and head, an epidermal hyperproliferation, especially psoriasis, prostate hyperplasia, a neoplasia, especially of epithelial character, preferably mammary carcinoma, or a leukemia. Most preferred are tumors that contain active and/or overexpressed hsp90 client proteins (e.g., ErbB-2, and Braf).

Compounds of formula (I) are able to bring about the regression of tumors and to prevent the formation of tumor metastases and the growth of (also micro)metastases. In addition they can be used in epidermal hyperproliferation (e.g. psoriasis), in prostate hyperplasia, and in the treatment of neoplasias, especially of epithelial character, for example mammary carcinoma.

Compounds of formula (I) can also be used to treat or prevent fibrogenic disorders such as scleroderma (systemic sclerosis); diseases associated with protein aggregation and amyloid formation such as Huntington's disease; inhibition of the replication of hepatitis C virus and treating hepatitis C virus; treating tumors associated with viral infection such as human papilloma virus; and Inhibiting viruses dependent of heat-shock proteins.

The compounds of formula (I) have valuable pharmacological properties and are useful in the treatment of proliferative diseases.

The inhibition of Hsp90 is measured using the procedure, with minor modifications, described in Schilb et al. Development and Implementation of a Highly Miniaturized Confocal 2D-FIDA-Based Analysis-Based High-Throughput Screening Assay to Search for Active Site Modulators of the Human Heat Shock Protein 90β, J of Biomolecular Screening 2003 in press.

The procedure is repeated for different concentrations of test compound selected to cover the range of 0% to 100% inhibition and the concentration at which 50% inhibition of Hsp90 occurs (IC₅₀) for each compound is determined from concentration-inhibition curves in a conventional manner.

The compounds of the Examples hereinbelow have IC₅₀ values of the order of 100 μM or less in the above mentioned FIDA assay, specifically ≦50 μM.

### Synthetic Procedure

Compounds of formula (I) where R⁴ is OH, compounds of formula (I), are prepared by acylating substituted fluoro-methoxybenzenes by Friedel-Crafts. The thus obtained substituted fluoro-methoxy-phenyl-ethanones are reacted in the presence of hydrazine monohydrate to give the corresponding 6-methoxy-indazoles, which were subsequently transformed into the 6-hydroxy-indazoles (I).

The following reaction conditions are preferred, respectively:

The syntheses of 1H-indazol-6-ole derivatives (i) were carried out by using standard procedures as outlined in Scheme 1. Substituted fluoro-methoxybenzenes (ii) were acylated by Friedel-Crafts acylation using aluminium trichloride (1.25-1.5 equivalents) in dichloromethane, whereas the reactions were performed at 0° C. during 4 h (Step A). The thus obtained substituted fluoro-methoxy-phenyl-ethanones (III) were refluxed in dioxane in the presence of 5 equivalents of hydrazine monohydrate for 2 h to give the corresponding 6-methoxy-indazoles (iv) (Step B), which were subsequently transformed into the 6-hydroxy-indazoles (i) by means of 1 N boron tribromide (3-6 equivalents) in dichloromethane by stirring the Reaction mixtures at 5° C. for 1-6 days (Step C).

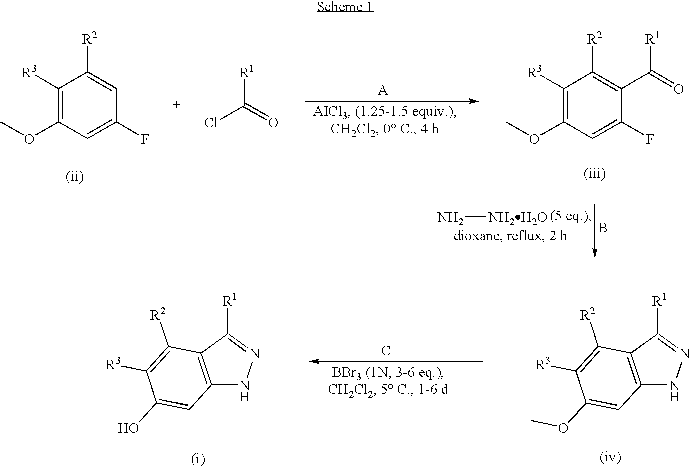

and, if desired, after reaction (A), (B) or (C), transforming an obtainable compound of formula (I) into a different compound of formula (I), or into a salt thereof, or vice versa from a salt to free compound, in a conventional manner; and/or separating an obtainable mixture of isomers of compounds of formula (I) into the individual isomers; where for all reactions mentioned functional groups in the starting materials that shall not take part in the reaction are, if required, present in protected form by readily removable protecting groups, and any protecting groups are subsequently removed.

The compounds in free or salt form can be obtained in the form of hydrates or solvates containing a solvent used for crystallization.

Salts of compound of formula (I) can be prepared in a customary manner from the free compounds, and vice versa.

Mixtures of isomers obtainable according to the invention can be separated in a manner known per se into the individual isomers; diastereoisomers can be separated, for example, by partitioning between polyphasic solvent mixtures, recrystallization and/or chromatographic separation, for example over silica gel or by e.g. medium pressure liquid chromatography over a reversed phase column, and racemates can be separated, for example, by the formation of salts with optically pure salt-forming reagents and separation of the mixture of diastereoisomers so obtainable, for example by means of fractional crystallization, or by chromatography over optically active column materials.

Intermediates and final products can be worked up and/or purified according to standard methods, e.g. using chromatographic methods, distribution methods, (re-) crystallization, and the like.

### General Process Conditions

The following applies in general to all processes mentioned hereinbefore and hereinafter, while reaction conditions specifically mentioned above or below are preferred:

All the above-mentioned process steps can be carried out under reaction conditions that are known per se, preferably those mentioned specifically, in the absence or, customarily, in the presence of solvents or diluents, preferably solvents or diluents that are inert towards the re-agents used and dissolve them, in the absence or presence of catalysts, condensation or neutralizing agents, for example ion exchangers, such as cation exchangers, e.g. in the H⁺ form, depending on the nature of the reaction and/or of the reactants at reduced, normal or elevated temperature, for example in a temperature range of from about −100° C. to about 190° C., preferably from approximately −80° C. to approximately 150° C., for example at from −80 to −60° C., at room temperature, at from −20 to 40° C. or at reflux temperature, under atmospheric pressure or in a closed vessel, where appropriate under pressure, and/or in an inert atmosphere, for example under an argon or nitrogen atmosphere.

At all stages of the reactions, mixtures of isomers that are formed can be separated into the individual isomers as described above.

The solvents from which those solvents that are suitable for any particular reaction may be selected include those mentioned specifically or, for example, water, esters, such as lower alkyl-lower alkanoates, for example ethyl acetate, ethers, such as aliphatic ethers, for example diethyl ether, or cyclic ethers, for example tetrahydrofuran or dioxane, liquid aromatic hydrocarbons, such as benzene or toluene, alcohols, such as methanol, ethanol or 1- or 2-propanol, nitriles, such as acetonitrile, halogenated hydrocarbons, such as methylene chloride or chloroform, acid amides, such as dimethylformamide or dimethyl acetamide, bases, such as heterocyclic nitrogen bases, for example pyridine or N-methylpyrrolidin-2-one, carboxylic acid anhydrides, such as lower alkanoic acid anhydrides, for example acetic anhydride, cyclic, linear or branched hydrocarbons, such as cyclohexane, hexane or isopentane, or mixtures of those solvents, for example aqueous solutions, unless otherwise indicated in the description of the processes. Such solvent mixtures may also be used in working up, for example by chromatography or partitioning.

The compounds, including their salts, may also be obtained in the form of hydrates, or their crystals may, for example, include the solvent used for crystallization. Different crystalline forms may be present.

### Pharmaceutical Compositions

The invention relates also to pharmaceutical compositions comprising a compound of formula (I), to their use in the therapeutic (in a broader aspect of the invention also prophylactic) treatment or a method of treatment of proliferative disease, especially the preferred diseases mentioned above, to the compounds for said use and to the preparation of pharmaceutical preparations, especially for said uses.

The pharmacologically acceptable compounds of the present invention may be used, for example, for the preparation of pharmaceutical compositions that comprise an effective amount of a compound of the formula (I), or a pharmaceutically acceptable salt thereof, as active ingredient together or in admixture with a significant amount of one or more inorganic or organic, solid or liquid, pharmaceutically acceptable carriers.

The invention relates also to a pharmaceutical composition that is suitable for administration to a warm-blooded animal, especially a human (or to cells or cell lines derived from a warm-blooded animal, especially a human, e.g. lymphocytes), for the treatment or, in a broader aspect of the invention, prevention of (=prophylaxis against) a disease that responds to inhibition of Hsp90 activity, comprising an amount of a compound of formula (I) or a pharmaceutically acceptable salt thereof, which is effective for said inhibition, especially the in, together with at least one pharmaceutically acceptable carrier.

The pharmaceutical compositions according to the invention are those for enteral, such as nasal, rectal or oral, or parenteral, such as Intramuscular or intravenous, administration to warm-blooded animals (especially a human), that comprise an effective dose of the pharmacologically active Ingredient, alone or together with a significant amount of a pharmaceutically acceptable carrier. The dose of the active ingredient depends on the species of warm-blooded animal, the body weight, the age and the individual condition, individual pharmacokinetic data, the disease to be treated and the mode of administration.

The invention relates also to a method of treatment for a disease that responds to inhibition of Hsp90; which comprises administering an (against the mentioned disease) prophylactically or especially therapeutically effective amount of a compound of formula (I) according to the invention, especially to a warm-blooded animal, for example a human, that, on account of one of the mentioned diseases, requires such treatment.

The dose of a compound of the formula (I) or a pharmaceutically acceptable salt thereof to be administered to warm-blooded animals, for example humans of approximately 70 kg body weight, is preferably from approximately 3 mg to approximately 10 g, more preferably from approximately 10 mg to approximately 1.5 g, most preferably from about 100 mg to about 1000 mg/person/day, divided preferably into 1-3 single doses which may, for example, be of the same size. Usually, children receive half of the adult dose.

The pharmaceutical compositions comprise from approximately 1% to approximately 95%, preferably from approximately 20% to approximately 90%, active ingredient. Pharmaceutical compositions according to the invention may be, for example, in unit dose form, such as in the form of ampoules, vials, suppositories, dragées, tablets or capsules.

The pharmaceutical compositions of the present invention are prepared in a manner known per se, for example by means of conventional dissolving, lyophilizing, mixing, granulating or confectioning processes.

Solutions of the active ingredient, and also suspensions, and especially isotonic aqueous solutions or suspensions, are preferably used, it being possible, for example in the case of lyophilized compositions that comprise the active Ingredient alone or together with a carrier, for example mannitol, for such solutions or suspensions to be produced prior to use. The pharmaceutical compositions may be sterilized and/or may comprise excipients, for example preservatives, stabilizers, wetting and/or emulsifying agents, solubilizers, salts for regulating the osmotic pressure and/or buffers, and are prepared in a manner known per se, for example by means of conventional dissolving or lyophilizing processes. The said solutions or suspensions may comprise viscosity-increasing substances, such as sodium carboxymethylcellulose, carboxymethylcellulose, dextran, polyvinylpyrrolidone or gelatin.

Suspensions in oil comprise as the oil component the vegetable, synthetic or semi-synthetic oils customary for injection purposes. There may be mentioned as such especially liquid fatty acid esters that contain as the acid component a long-chained fatty acid having from 8-22, especially from 12-22, carbon atoms, for example lauric acid, tridecylic acid, myristic acid, pentadecylic acid, palmitic acid, margaric acid, stearic acid, arachidic acid, behenic acid or corresponding unsaturated acids, for example oleic acid, elaidic acid, erucic acid, brasidic acid or linoleic acid, if desired with the addition of antioxidants, for example vitamin E, β-carotene or 3,5-di-tert-butyl-4-hydroxytoluene. The alcohol component of those fatty acid esters has a maximum of 6 carbon atoms and is a mono- or poly-hydroxy, for example a mono-, di- or tri-hydroxy, alcohol, for example methanol, ethanol, propanol, butanol or pentanol or the isomers thereof, but especially glycol and glycerol. The following examples of fatty acid esters are therefore to be mentioned: ethyl oleate, isopropyl myristate, isopropyl palmitate, “Labrafil M 2375” (polyoxyethylene glycerol trioleate, Gattefossé, Paris), “Miglyol 812” (triglyceride of saturated fatty acids with a chain length of C₈ to C₁₂, Hüls A G, Germany), but especially vegetable oils, such as cottonseed oil, almond oil, olive oil, castor oil, sesame oil, soybean oil and more especially groundnut oil.

The injection compositions are prepared in customary manner under sterile conditions; the same applies also to introducing the compositions into ampoules or vials and sealing the containers.

Pharmaceutical compositions for oral administration can be obtained by combining the active ingredient with solid carriers, if desired granulating a resulting mixture, and processing the mixture, if desired or necessary, after the addition of appropriate excipients, into tablets, dragée cores or capsules. It is also possible for them to be incorporated into plastics carriers that allow the active ingredients to diffuse or be released in measured amounts.

Suitable carriers are especially fillers, such as sugars, for example lactose, saccharose, mannitol or sorbitol, cellulose preparations and/or calcium phosphates, for example tricalcium phosphate or calcium hydrogen phosphate, and binders, such as starch pastes using for example corn, wheat, rice or potato starch, gelatin, tragacanth, methylcellulose, hydroxypropylmethylcellulose, sodium carboxymethylcellulose and/or polyvinylpyrrolidone, and/or, if desired, disintegrators, such as the above-mentioned starches, and/or carboxymethyl starch, crosslinked polyvinylpyrrolidone, agar, alginic acid or a salt thereof, such as sodium alginate. Excipients are especially flow conditioners and lubricants, for example silicic acid, talc, stearic acid or salts thereof, such as magnesium or calcium stearate, and/or polyethylene glycol. Dragée cores are provided with suitable, optionally enteric, coatings, there being used, inter alia, concentrated sugar solutions which may comprise gum arabic, talc, polyvinylpyrrolidone, polyethylene glycol and/or titanium dioxide, or coating solutions in suitable organic solvents, or, for the preparation of enteric coatings, solutions of suitable cellulose preparations, such as ethylcellulose phthalate or hydroxypropylmethylcellulose phthalate. Capsules are dry-filled capsules made of gelatin and soft sealed capsules made of gelatin and a plasticizer, such as glycerol or sorbitol. The dry-filled capsules may comprise the active Ingredient in the form of granules, for example with fillers, such as lactose, binders, such as starches, and/or glidants, such as talc or magnesium stearate, and if desired with stabilizers. In soft capsules the active Ingredient is preferably dissolved or suspended in suitable oily excipients, such as fatty oils, paraffin oil or liquid polyethylene glycols, it being possible also for stabilizers and/or antibacterial agents to be added. Dyes or pigments may be added to the tablets or dragée coatings or the capsule casings, for example for identification purposes or to indicate different doses of active ingredient.

### Combinations

The compounds of the present invention may be administered alone or in combination with other anticancer agents, such as other antiproliferative agents and compounds that inhibit tumor angiogenesis, for example, the protease inhibitors; epidermal growth factor receptor kinase inhibitors; vascular endothelial growth factor receptor kinase inhibitors and the like; cytotoxic drugs, such as antimetabolites, like purine and pyrimidine analog antimetabolites; antineoplastic antimetabolites; antimitotic agents like microtubule stabilizing drugs and antimitotic alkaloids; platinum coordination complexes; anti-tumor antibiotics; alkylating agents, such as nitrogen mustards and nitrosoureas; endocrine agents, such as adrenocorticosteroids, androgens, anti-androgens, estrogens, anti-estrogens, aromatase inhibitors, gonadotropin-releasing hormone agonists and somatostatin analogues and compounds that target an enzyme or receptor that is overexpressed and/or otherwise Involved a specific metabolic pathway that is upregulated in the tumor cell, for example ATP and GTP phosphodiesterase inhibitors, histone deacetylase inhibitors, bisphosphonates; protein kinase Inhibitors, such as serine, threonine and tyrosine kinase inhibitors, for example, Abelson protein tryosine kinase and the various growth factors, their receptors and kinase inhibitors therefore, such as, epidermal growth factor receptor kinase Inhibitors, vascular endothelial growth factor receptor kinase inhibitors, fibroblast growth factor inhibitors, insulin-like growth factor receptor inhibitors and platelet-derived growth factor receptor kinase inhibitors and the like; compounds targeting, decreasing or inhibiting the activity of the Axl receptor tyrosine kinase family, the c-Met receptor or the Kit/SCFR receptor tyrosine kinase; methionine aminopeptidase inhibitors; matrix metalloproteinase inhibitors (“(MMP”); agents used in the treatment of hematologic malignancies; inhibitors of FMS-like tyrosine kinase receptors (Flt-3R); other Hsp90 inhibitors; antiproliferative antibodies such as trastuzumab (Herceptin™), Trastuzumab-DM1, erlotinib (Tarceva™), bevacizumab (Avastin™), rituximab (Rituxan®), PRO64553 (anti-CD40) and 2C4 Antibody; antibodies such as intact monoclonal antibodies, polyclonal antibodies; further anti-angiogenic compounds such as thalidomide and TNP-470; compounds which target, decrease, or inhibit the activity of a protein or lipid phosphatase; compounds which induce cell differentiation processes; heparanase inhibitors; biological response modifiers; inhibitors of Ras oncogenic isoforms, e.g. farnesyl transferase inhibitors; telomerase inhibitors, methionine aminopeptidase inhibitors; proteasome inhibitors; and cyclooxygenase inhibitors, for example, cyclooxygenase-1 or -2 inhibitors. Also included are temozolomide, bengamides and m-Tor inhibitors.

The structure of the active agents identified by code nos., generic or trade names may be taken from the actual edition of the standard compendium “The Merck Index” or from databases, e.g. Patents International (e.g. IMS World Publications).

The above-mentioned compounds, which can be used in combination with a compound of the formula (I), can be prepared and administered as described in the art such as in the documents cited above.

A compound of the formula (I) may also be used to advantage in combination with known therapeutic processes, e.g., the administration of hormones or especially radiation.

A compound of formula (I) may in particular be used as a radiosensitizer, especially for the treatment of tumors which exhibit poor sensitivity to radiotherapy.

The following examples serve to illustrate the invention without limiting the scope thereof:

### Syntheses General Conditions:

Flash chromatography was performed by using silica gel (Merck; 40-63 μm). For thin layer chromatography, precoated silica gel (Merck 60 F254) plates are used. Detection of the components was made by UV light (254 nm). HPLC was performed on an Agilent HP 1100 using a Nucleosil 100-3 C18 HD 125×4.0 mm column (1 mL/min; 20%->100% B TFA in 7 min. solvent A=0.1% TFA in water, solvent B=0.1% TFA in acetonitrile. Electrospray mass spectra were obtained with a Fisons Instruments VG Platform II; Commercially available solvents and chemicals were used for syntheses.

### Examples 1-5

The syntheses of 1H-indazol-6-oles were carried out by using standard procedures as outlined in Scheme 1 above. Substituted fluoro-methoxybenzenes (II) were acylated with phenyl acetic acid chloride or acetic acid chloride, respectively, using aluminium trichloride (1.25-1.5 equivalents) in dichloromethane, whereas the reactions were performed at 0° C. during 4 h. The thus obtained substituted fluoro-methoxy-phenyl-ethanones (III) were refluxed in dioxane in the presence of 5 equivalents of hydrazine monohydrate for 2 h to give the corresponding 6-methoxy-indazoles (iv), which were subsequently transformed into the 6-hydroxy-indazoles (i) by means of 1 N boron tribromide (3-6 equivalents) in dichloromethane by stirring the reaction mixtures at 5° C. for 1-6 days.

| | | | HPLC | MS |
|---|---|---|---|---|
| EX | Name | MW | t_{R} [min] | [M + H]⁺ |
| 1 | 3-Benzyl-4-fluoro-1H-indazol-6-ol | 242.25 | 7.02 | 243 |
| 2 | 3-Benzyl-5-chloro-1H-indazol-6-ol | 258.71 | 5.29 | 259/261 |
| 3 | 3-Benzyl-1H-indazole-4,6-diol | 240.26 | 3.58 | 241 |
| 4 | 3-Methyl-1H-indazole-4,6-diol | 164.17 | 1.20 | 165 |
| 5 | 3-Benzyl-5-ethyl-1H-indazol-6-ol | 252.32 | 5.18 | 253 |

### Example 6

### Tablets 1 Comprising Compounds of the Formula (I)

Tablets, comprising, as active ingredient, 50 mg of any one of the compounds of formula (I) mentioned in the preceding Examples 1-5 of the following composition are prepared using routine methods:

| Composition: | | |
|---|---|---|
| Active Ingredient | 50 | mg |
| Wheat starch | 60 | mg |
| Lactose | 50 | mg |
| Colloidal silica | 5 | mg |
| Talcum | 9 | mg |
| Magnesium stearate | 1 | mg |
| | 175 | mg |

Manufacture: The active ingredient is combined with part of the wheat starch, the lactose and the colloidal silica and the mixture pressed through a sieve. A further part of the wheat starch is mixed with the 5-fold amount of water on a water bath to form a paste and the mixture made first is kneaded with this paste until a weakly plastic mass is formed.

The dry granules are pressed through a sieve having a mesh size of 3 mm, mixed with a pre-sieved mixture (1 mm sieve) of the remaining corn starch, magnesium stearate and talcum and compressed to form slightly biconvex tablets.

### Example 7

### Tablets 2 Comprising Compounds of the Formula (I)

Tablets, comprising, as active ingredient, 100 mg of any one of the compounds of formula (I) of Examples 1-5 are prepared with the following composition, following standard procedures:

| Composition: | | |
|---|---|---|
| Active Ingredient | 100 | mg |
| Crystalline lactose | 240 | mg |
| Avicel | 80 | mg |
| PVPPXL | 20 | mg |
| Aerosil | 2 | mg |
| Magnesium stearate | 5 | mg |
| | 447 | mg |

Manufacture: The active ingredient is mixed with the carrier materials and compressed by means of a tabletting machine (Korsch EKO, Stempeldurchmesser 10 mm).

### Example 8

### Capsules

Capsules, comprising, as active ingredient, 100 mg of any one of the compounds of formula (I) given in Examples 1-5, of the following composition are prepared according to standard procedures:

| Composition: | | |
|---|---|---|
| Active Ingredient | 100 | mg |
| Avicel | 200 | mg |
| PVPPXL | 15 | mg |
| Aerosil | 2 | mg |
| Magnesium stearate | 1.5 | mg |
| | 318.5 | mg |

Manufacturing is done by mixing the components and filling them into hard gelatine capsules, size 1.

What is claimed is:

1. A method of treating a proliferative disease comprising administering a compound of the formula (I) 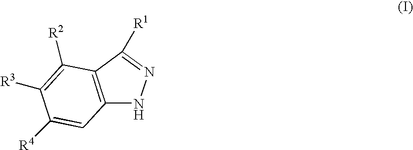
wherein:
R¹ is substituted or unsubstituted lower alkyl, substituted or unsubstituted aryl, or substituted or unsubstituted aryl lower alky;
R² is H, halo, hydroxy, lower alkyl or a group of the formula:
—Y—R⁵
where Y is O, N, S or lower alkyl and R⁵ is substituted or unsubstituted lower alkyl, or substituted or unsubstituted aryl;
R³ is H, halo, or substituted or unsubstituted lower alkyl, substituted or unsubstituted aryl, substituted or unsubstituted cycloalkyl, substituted or unsubstituted cycloalkyl-alkyl or substituted or unsubstituted arylalkyl;
R⁴ is H or OH;
or pharmaceutically acceptable salts thereof.

2. A method according to claim 1, wherein the proliferative disease is a benign or malignant tumor, a carcinoma of the brain, kidney, liver, adrenal gland, bladder, breast, stomach, gastric tumors, ovaries, colon, rectum, prostate, pancreas, lung, vagina, thyroid, sarcoma, glioblastomas, multiple myeloma or gastrointestinal cancer, colon carcinoma or colorectal adenoma, or a tumor of the neck and head, an epidermal hyperproliferation, prostate hyperplasia, a neoplasia, or a leukemia.

3. A method according to claim 1 wherein the proliferative disease is selected from cancers and tumors which overexpress Hsp90.

4. A compound of formula (I):
R¹ is lower alkyl (such as methyl or ethyl); substituted lower alkyl (such as benzyl or phenyl ethyl) or phenyl which is unsubstituted or substituted with H, lower alkyl, lower alkoxy (such as methoxy), amine lower alkoxy (such as amino ethoxy), lower alkyl amino alkoxy or dialkylamino alkoxy (such as methyl amino ethoxy or dimethyl amino ethoxy);
R² is H, halo (such as F), hydroxy, lower alkyl or a group of the formula:
—Y—R⁵
where Y is O, N, S or lower alkyl and R⁵ is lower alkyl or aryl; examples of R⁵ include phenyl, naphthyl, phenoxy, phenyl amino, phenyl thio, phenyl ethyl, benzyl, wherein the phenyl or naphthyl group of R⁵ is preferably substituted with H, lower alkyl, lower alkoxy (such as methoxy), halo, trifluoromethyl, N-phenylacetamide, amine lower alkoxy (such as amino ethoxy), lower alkyl amino alkoxy or dialkylamino alkoxy (such as methyl amino ethoxy or dimethyl amino ethoxy);
R³ is H, Cl, methyl, trifluoromethyl, ethyl, propyl, isopropyl, butyl, tert-butyl or iso-butyl or pharmaceutically acceptable salts thereof.

5. A compound according to claim 4 wherein
R¹ is benzyl or methyl;
R² is F, H or OH;
R³ is H, Cl or ethyl; and
R⁴ is OH.

6. A pharmaceutical composition comprising a compound according to claim 4.

7. A pharmaceutical composition comprising a compound according to claim 4 and an acceptable pharmaceutical carrier.

8. A compound according to claim 1 selected from the group consisting of:
3-Benzyl-4-fluoro-1H-Indazol-6-ol;
3-Benzyl-5-chloro-1H-indazol-6-ol;
3-Benzyl-1H-indazole-4,6-diol;
3-Methyl-1H-indazole-4,6-diol;
3-enzyl-5-ethyl-1H-indazol-6-ol;
and pharmaceutically acceptable salts thereof.

9. Use of a compound according to claim 1 in the preparation of a pharmaceutical composition for use in the treatment of a disease dependent on Hsp90.

10. A process to prepare a compound according to claim 4 comprising:
a) acylating a substituted fluoro-methoxybenzene by a Friedel-Crafts reaction;
b) reacting the substituted fluoro-methoxy-phenyl-ethanones obtained in (a) with hydrazine monohydrate to give the corresponding 6-methoxy-indazole,
(c) transforming the product of step (b) into the 6-hydroxy-indazoles.
